(19) United States
(12) Patent Application Publication
(10) Pub. No.: US 2026/0322193 A1
(43) Pub. Date: Oct. 15, 2026

(54) NEGATIVE Q-FLUX INTERNAL PERMANENT MAGNETS FOR A ROTOR ASSEMBLY

(71) Applicant: GM Global Technology Operations LLC, Detroit, MI (US)

(72) Inventors: Vincent Fedida, Shanghai (CN); Jian Yao, Shanghai (CN); Chengwu Duan, Shanghai (CN)

(21) Appl. No.: 19/176,647

(22) Filed: Apr. 11, 2025

(30) Foreign Application Priority Data
Apr. 10, 2025 (CN) 202510445963.0

(51) Int. Cl. H02K 1/274; H02K 1/02; H02K 21/14

(52) U.S. Cl. CPC H02K 1/274; H02K 1/02; H02K 21/14; H02K 2201/03; H02K 2201/15

(57) ABSTRACT

A rotor, an electric motor, and an electrified vehicle is provided. The rotor includes a rotor core with plurality of the poles, a plurality of rotor cavities defined by each of a plurality of the poles, and a plurality of permanent magnets disposed in the rotor cavities. The rotor cavities include a first subset and a second subset of rotor cavities spaced apart from each other. The first subset includes a first inner cavity and a second inner cavity, and the second subset includes a first outer cavity and a second outer cavity. The second subset is disposed between the first subset and the outer rotor surface. The plurality of permanent magnets includes a first inner magnet disposed in the first inner cavity and a second inner magnet disposed in the second inner cavity, and the second inner magnet is shorter in length than the first inner magnet.

### INTRODUCTION

The present disclosure relates to a rotor for an electric motor, and more particularly, to an electric motor with an arrangement of permanent magnets.

A rotary electric machine of the type used in an electric drive system of an electric vehicle operates in a motoring mode in which output torque is delivered to a coupled load (e.g., one or more road wheels of a motor vehicle) and/or a generating mode in which machine rotation is used to generate electricity. In a typical configuration, the electric machine includes a cylindrical rotor formed from an annular stack of thin magnetic rotor lamination layers. The cylindrical rotor may include a plurality of permanent magnets.

Permanent magnets may include, for example, neodymium (Nd) magnets, also known as NdFeB, NIB, or Neo magnets. Nd magnets are rare-earth magnets made from an alloy of neodymium (Nd), iron (Fe), and/or boron (B). Nd magnets have high-coercivity (i.e., resistance to being demagnetized) and a high magnetic energy density. Permanent magnets can be disposed within openings or slots in the rotor to generate motor flux having a flux field that follows a predefined path, which can be boosted and/or opposed. Boosting the flux field increases torque production of the electric machine, while opposing the flux field will limit torque production of the electric machine. The configuration and/or topology of the permanent magnets disposed within the rotor can determine the electric machine’s power density.

While present rotors achieve their intended purpose, there is a need for new and improved rotors that offer improved torque production and power density within the electric motor.

### SUMMARY

According to several aspects of the present disclosure, a rotor is provided. The rotor includes a rotor core defining an outer rotor surface and an inner rotor surface opposite the inner rotor surface, a plurality of rotor cavities defined by each of a plurality of poles, and a plurality of permanent magnets respectively disposed in one of the plurality of rotor cavities. The rotor core includes a plurality of the poles arranged annularly about a rotational axis. The rotor cavities are disposed near the outer rotor surface, and the plurality of rotor cavities includes at least a first subset and a second subset of rotor cavities spaced apart from each other. The first subset includes a first inner cavity and a second inner cavity in a V-shaped configuration, and the second subset includes a first outer cavity and a second outer cavity in a V-shaped configuration. The second subset is disposed between the first subset and the outer rotor surface. The plurality of permanent magnets includes a first inner magnet disposed in the first inner cavity and a second inner magnet disposed in the second inner cavity, and the second inner magnet is shorter in length than the first inner magnet.

In accordance with another aspect of the disclosure, the plurality of permanent magnets includes an alloy of a rare earth element including at least one of neodymium or samarium.

In accordance with another aspect of the disclosure, the second inner magnet is equal in length to each of the plurality of permanent magnets in the second subset.

In accordance with another aspect of the disclosure, the second inner cavity includes a mechanical bridge disposed between the second inner magnet and the outer rotor surface, and the mechanical bridge is aligned with a q-axis.

In accordance with another aspect of the disclosure, a leakage bridge is disposed between the second inner cavity and is aligned with a q-axis.

In accordance with another aspect of the disclosure, a mechanic web is disposed between the first inner cavity and the second inner cavity, and the mechanic web is offset from a center pole axis extending through a rotor center to a center of a pole such that the mechanic web is more proximate the second inner magnet than the first inner magnet.

In accordance with another aspect of the disclosure, a first magnet and a second magnet are disposed in the second inner cavity, and the first magnet is a different grade than the second magnet.

In accordance with another aspect of the disclosure, the first magnet has a higher grade than the second magnet, and the first magnet is positioned closer to a rotor center than the second magnet.

In accordance with another aspect of the disclosure, the second magnet has a greater width than the first magnet, a first edge of the second magnet is aligned with a first edge of the first magnet, and a second edge of the second magnet is offset with a second edge of the first magnet.

In accordance with another aspect of the disclosure, the second magnet has a greater width than the first magnet, a first side of length of the second magnet is offset with a first side of length with the first magnet, and a second side of length of the second magnet is offset with a second side of length of the first magnet.

According to several aspects of the present disclosure, an electric motor is provided. The electric motor includes a stator including a plurality of electrical conductors and a rotor concentrically disposed relative to the stator. The rotor is rotatable relative to the stator about a rotational axis, and the rotor is spaced apart from the stator to define an air gap between the stator and the rotor. The rotor includes a rotor core defining an outer rotor surface and an inner rotor surface opposite the inner rotor surface, a plurality of rotor cavities defined by each of the plurality of poles, and a plurality of permanent magnets respectively disposed in one of the plurality of rotor cavities. The rotor core includes a plurality of poles arranged annularly about the rotational axis. The rotor cavities are disposed near the outer rotor surface, and the plurality of rotor cavities includes at least a first subset and a second subset of rotor cavities spaced apart from each other. The first subset includes a first inner cavity and a second inner cavity in a V-shaped configuration, and the second subset includes a first outer cavity and a second outer cavity in a V-shaped configuration. The second subset is disposed between the first subset and the outer rotor surface. The plurality of permanent magnets includes a first inner magnet disposed in the first inner cavity and a second inner magnet disposed in the second inner cavity, and the second inner magnet is shorter in length than the first inner magnet.

In accordance with another aspect of the disclosure, the second inner magnet is equal in length to each of the plurality of permanent magnets in the second subset.

In accordance with another aspect of the disclosure, the second inner cavity includes a mechanical bridge disposed between the second inner magnet and the outer rotor surface, and the mechanical bridge is aligned with a d-axis.

In accordance with another aspect of the disclosure, a leakage bridge is disposed between the second inner cavity and is aligned with a q-axis.

In accordance with another aspect of the disclosure, a mechanical web is disposed between the first inner cavity and the second inner cavity, and the mechanic web is offset from a center pole axis extending through a rotor center through a center of a pole such that the mechanic web is more proximate the second inner magnet than the first inner magnet.

In accordance with another aspect of the disclosure, a first magnet and a second magnet is disposed in the second inner cavity, and the first magnet is a different grade than the second magnet.

In accordance with another aspect of the disclosure, the first magnet has a higher grade than the second magnet, and the first magnet is more proximate to a center pole axis than the second magnet.

In accordance with another aspect of the disclosure, the second magnet has a greater width than the first magnet, a first side of length of the second magnet is aligned with a first side of length with the first magnet, and a second side of length of the second magnet is offset with a second side of length of the first magnet.

In accordance with another aspect of the disclosure, the second magnet has a greater width than the first magnet, a first side of length of the second magnet is offset with a first side of length with the first magnet, and a second side of length of the second magnet is offset with a second side of length of the first magnet.

According to several aspects of the present disclosure, an electrified vehicle is provided. The electrified vehicle includes an electric drive system having an electric motor including a stator including a plurality of electrical conductors and a rotor concentrically disposed in relation to the stator. The rotor is rotatable relative to the stator about a rotational axis, and the rotor is spaced apart from the stator to define an air gap between the stator and the rotor. The rotor includes a rotor core defining an outer rotor surface and an inner rotor surface opposite the inner rotor surface, a plurality of rotor cavities defined by each of a plurality of poles, and a plurality of permanent magnets respectively disposed in one of the plurality of rotor cavities. The rotor core includes a plurality of poles arranged annularly about the rotational axis. The rotor cavities are disposed near the outer rotor surface, and the plurality of rotor cavities includes at least a first subset and a second subset of rotor cavities spaced apart from each other. The first subset includes a first inner cavity and a second inner cavity in a V-shaped configuration, and the second subset includes a first outer cavity and a second outer cavity in a V-shaped configuration. The second subset is disposed between the first subset and the outer rotor surface. The plurality of permanent magnets includes a first inner magnet disposed in the first inner cavity and a second inner magnet disposed in the second inner cavity, and the second inner magnet is shorter in length than the first inner magnet.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a schematic diagram of a vehicle including an electric motor, in accordance with the present disclosure.

FIG. 2 is a schematic cross-sectional view of the electric motor and rotor shown in FIG. 1, taken along section line 2-2 of FIG. 1, in accordance with the present disclosure.

FIG. 3 is cross section view illustrating multiple pole sections and a q-axis and d-axis of the rotor shown in FIG. 1, where the pole sections include a plurality of asymmetrical permanent magnets, in accordance with the present disclosure.

FIG. 4 is cross section view illustrating magnetic flux in the multiple pole sections of the rotor shown in FIG. 1, where the pole sections include a plurality of asymmetrical permanent magnets, in accordance with the present disclosure.

FIG. 5 is cross section view illustrating multiple pole sections of the rotor shown in FIG. 1, where the pole sections include a plurality of asymmetrical permanent magnets and a mechanical bridge in each pole section, in accordance with the present disclosure.

FIG. 6 is cross section view illustrating the multiple pole sections of the rotor shown in FIG. 1, where the pole sections include a plurality of asymmetrical permanent magnets and a mechanical bridge, in accordance with the present disclosure.

FIG. 7 is cross section view illustrating the multiple pole sections of the rotor shown in FIG. 1, where the pole sections include a plurality of asymmetrical permanent magnets, a mechanical bridge, a leakage bridge, and an offset mechanical web, in accordance with the present disclosure.

FIG. 8 is cross section view illustrating the multiple pole sections of the rotor shown in FIG. 1, where the pole sections include a plurality of asymmetrical permanent magnets with differing grades, in accordance with the present disclosure.

FIG. 9 is cross section view illustrating the multiple pole sections of the rotor shown in FIG. 1, where the pole sections include a plurality of asymmetrical permanent magnets with differing grades and a demagnetization adjusted size, in accordance with the present disclosure.

FIG. 10 is cross section view illustrating the multiple pole sections of the rotor shown in FIG. 1, where the pole sections include a plurality of asymmetrical permanent magnets with differing grades and a demagnetization adjusted size and position, in accordance with the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. The following description is merely exemplary in nature and is not intended to limit the present disclosure, application, or uses.

A rotor, an electric motor, and an electrified vehicle are disclosed herein. The rotor includes an arrangement of asymmetrical permanent magnets. The rotor and electric motor provide a higher efficiency in a driving cycle and a lower amount of permanent magnets. The permanent magnets are asymmetrically arranged and used to give the magnetic flux density in the rotor an orientation along the negative q-axis at no-load allowing a delay of rotor saturation and increasing reluctance torque.

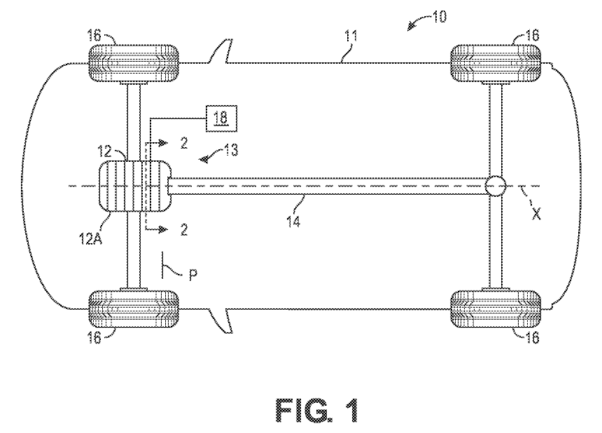

FIG. 1 illustrates a vehicle 10 including an electric motor 12 (i.e., an electric motor) configured to propel the vehicle 10. The electric motor 12 can be configured to provide torque or force to another component of the vehicle 10, thereby propelling the vehicle 10. The electric motor 12 is therefore part of a propulsion system 13 of the vehicle 10. Aside from propelling the vehicle 10, the electric motor 12 can be used to power other suitable devices. The electric motor 12 may be a brushless motor and includes six substantially identical interconnected segments 12A disposed side by side along a rotational axis X, which is defined along the length of the electric motor 12. It is contemplated, however, that the electric motor 12 may include more or fewer segments 12A. The number of interconnected segments 12A is directly related to the torque the electric motor 12 is capable of producing for powering the vehicle 10. The vehicle 10 includes a vehicle body 11, and the electric motor 12 is coupled to the vehicle body 11.

The vehicle 10 includes a driveline 14 having a transmission and a driveshaft (not shown). The driveline 14 is operatively connected between the electric motor 12 and the driven wheels 16 via one or more suitable couplers such as constant velocity and universal joints (not shown). The operative connection between electric motor 12 and the driveline 14 allows the electric motor 12 to supply torque to the driven wheels 16 in order to propel the vehicle 10.

The propulsion system 13 also includes a battery (or battery pack) 18 configured to supply electrical energy to the electric motor 12 and other vehicle systems (not shown). To do so, the battery 18 is electrically connected to the electric motor 12. Due to this electrical connection, the electric motor 12 is configured to receive electrical energy from the battery 18 and can operate as a generator when driven by a motive energy source of the vehicle 10 that is external to the electric motor 12. Such external motive energy may be, for example, provided by an internal combustion engine (not shown) or by the driven wheels 16 via vehicle inertia.

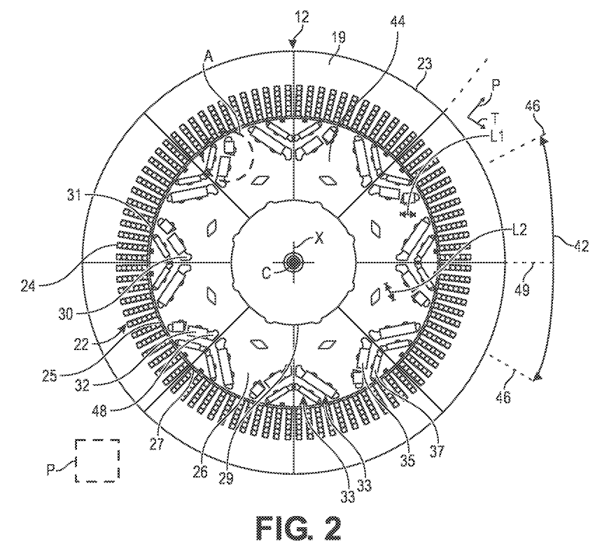

FIG. 2 shows a cross-sectional view of a portion of the electric motor 12 taken along a virtual plane P. The electric motor 12 includes a stator 20 having a stator core 19. The stator core 19 has apertures 22, and the stator 20 includes electrical conductors 24 disposed in the apertures 22. The electrical conductors 24 are electrically connected to the battery 18 (FIG. 1). This electrical connection allows the battery 18 (FIG. 1) to supply electrical energy to the electrical conductors 24. The stator 20 may have a substantially annular shape and may be disposed around the rotational axis X. Furthermore, the stator 20 may define an outer stator surface 23 and an inner stator surface 25 opposite the outer stator surface 23. Both the outer stator surface 23 and the inner stator surface 25 may define a circumference around the rotational axis X. The apertures 22 may be disposed closer to the inner stator surface 25 than the outer stator surface 23, and each is shaped and sized to receive one or more electrical conductors 24. As used herein, the term “apertures” includes without limitation slits, slots, openings, or any cavity in the stator 20 configured and shaped to receive at least one electrical conductor 24. The electrical conductors 24 may be made of a suitable electrically conductive material such as metallic materials like copper and aluminum. The electrical conductors 24 can be configured as bars or windings and may have any suitable shape such as substantially rectangular, cuboid, and cylindrical shapes. Irrespective of its shape, each electrical conductor 24 is shaped and sized to be received in one aperture 22.

The electric motor 12 further includes a rotor 26 disposed around the rotational axis X and within the stator 20. The stator 20 may be disposed concentrically with the rotor 26. The rotor 26 may include a variety of rotor types as long as the rotor has an interior permanent magnet motor (IPM) layout. The rotor 26 includes a rotor core 21 wholly or partly formed of a metallic material, such as stainless steel, may have a substantially annular shape, and defines a plurality of rotor cavities 30 and a plurality of permanent magnets 32 disposed within the rotor cavities 30. The rotor core 21 and stator 20 can be made of “electrical steel” or “silicon steel” and can be include multiple laminated layers (e.g., each layer about 0.25 millimeters (mm) thick). It is envisioned that the rotor cavities 30 may be configured as slots, although the rotor cavities 30 may be have alternative configurations. Additionally, the rotor 26 may include different cavity 30 configurations (e.g., one layer of cavities 30, two layers of cavities 30, three layers of cavities 30, and so forth). The permanent magnets 32 are tightly fitted in the rotator cavities 30 and may include an alloy of a rare earth element such as neodymium, samarium, or any other suitable ferromagnetic material. Suitable ferromagnetic materials may include, for example, a neodymium iron boron (NdFeB) alloy and/or a samarium cobalt (SmCo) alloy. The permanent magnets 32 may be disposed annularly around the rotational axis X and may be configured to magnetically interact with the electrical conductors 24. During operation of the electric motor 12, the rotor 26 revolves around the rotational axis X relative to the stator 20 in response to the magnetic flux developed between the electrical conductors 24 and the permanent magnets 32, thus generating drive torque to power the vehicle 10.

The rotor 26 defines an outer rotor surface 27 and an inner rotor surface 29 opposite the outer rotor surface 27. Both the outer rotor surface 27 and the inner rotor 29 may define a circumference around the rotational axis X. The electric motor 12 may define an air gap 31 between the inner stator surface 25 and the outer rotor surface 27. The air gap 31 may have a substantially annular shape and may span around the rotor 26. The rotor 26 includes a plurality of poles 42 arranged annularly around a rotor center C, which may coincide with the rotational axis X. Each pole 42 represents a magnetic pole of the electric motor 12. Though the drawings show eight poles 42, the rotor 26 may include more or fewer poles 42. Inter-polar bridges 44 separate consecutive poles 42 and can be elongated along respective inter-polar axes 46. Each inter-polar axis 46 extends through the rotor center C and substantially through the middle of a respective inter-polar bridge 44 and defines the demarcation between two consecutive poles 42. Consecutive poles 42 have opposite magnetic polarities. Each pole 42 further defines a center pole axis 49 extending through the rotator center C and substantially through the middle of the pole 42. The center pole axis 49 of each pole 42 may also intersect the rotational axis X.

Each pole 42 includes a plurality of magnetic layers 33. In the depicted embodiment, in each pole 42, the plurality of magnetic layers 33 includes a first subset 35 and a second subset 37. In the embodiment illustrated in FIG. 2, the first subset 35 is closer to the inner rotor surface 29 than the second subset 37, and the second subset 37 is closer to the outer rotor surface 27 than the first subset 35. In the depicted embodiments, the first subset 35 is the closest magnetic layer 33 to the inner rotor surface 29. As such, no other magnetic layer 33 is closer to the inner rotor surface 29 than the first subset 35.

Each magnetic layer 33 includes a plurality of permanent magnets 32, which are disposed in the rotor cavities 30. The rotor cavities 30 are arranged in cavity layers 48, which correspond to the magnetic layers 33. In each pole 42, the magnetic layers 33 are spaced apart from one another along a radial direction, which is indicated by arrow R. Although the drawings show two magnetic layers 33, each pole 42 may include more or fewer magnetic layers 33. In the depicted embodiment, each magnetic layer 33 only includes two permanent magnets 32 that are spaced apart from each other along a tangential direction, which is indicated by arrow T. In other words, as non-limiting example, each magnetic layer 33 only includes two permanent magnets 32 to maximize the reluctance torque of the electric motor 12 without increasing the spin loss. The tangential direction (as indicated by arrow T) may be perpendicular to the radial direction (indicated by arrow R). Each permanent magnet 32 may be a monolithic structure (i.e., a one-piece structure) or, in some instances, the permanent magnet 32 may include multiple magnets.

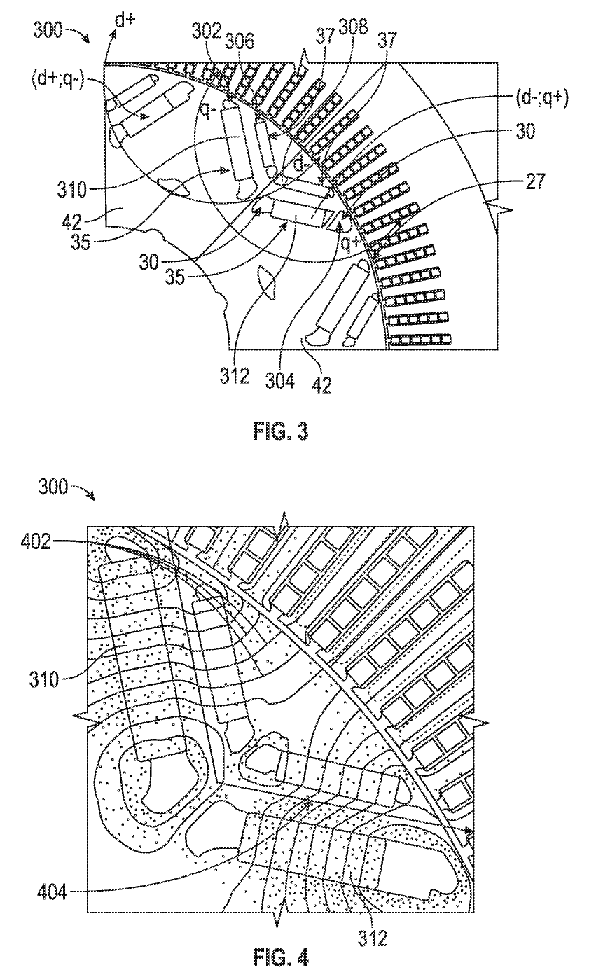

FIGS. 3 and 4 illustrate a rotor section 300 having two poles 42 including a first subset 35 and a second subset 37. In this embodiment, the rotor cavities 30 are disposed near the outer rotor surface 27. Each rotor cavity 30 includes at least a first subset 35 and a second subset 37 spaced apart from each other. The first subset 35 includes a first inner cavity 302 and a second inner cavity 304 in a V-shaped configuration, wherein the second subset 37 includes a first outer cavity 306 and a second outer cavity 308 also in a V-shaped configuration. The second subset 37 is disposed between the first subset 35 and the outer rotor surface 27. A plurality of permanent magnets 32 may be respectively disposed in each one of the plurality of rotor cavities 30. The plurality of permanent magnets 32 includes a first inner magnet 310 disposed in the first inner cavity 302 and a second inner magnet 312 disposed in the second inner cavity 304. In this embodiment, the second inner magnet 312 is shorter in length L than the first inner magnet 310, and the second inner magnet 312 is located deep inside the second inner cavity 304 (e.g., away from the airgap). Placing the second inner magnet 312 deep inside the inner cavity 304 orients the magnetic flux toward the negative q-axis. In some embodiments, the second inner magnet 312 is equal in length to each of the plurality of permanent magnets 32 in the second subset 37. A positive and negative d-axis (direct axis) and a positive and negative q-axis (quadrature axis) are shown. The d-axis is aligned with the magnetic field of the permanent magnets 32 on the rotor 26 and represents a component of the magnetic field that is directly aligned with the rotor's magnetic field. The q-axis is orthogonal (90 degrees) to the d-axis and represents a component of the magnetic field that is perpendicular to the rotor's magnetic field. The q-axis current is responsible for producing torque while the d-axis current can be used to control magnetic field strength. When the d-axis current is negative, it can weaken the magnetic field, a technique known as "field weakening." In order to maximize torque density, the electric motor 12 is designed with strong saturation on both the rotor 26 and the stator 20. Reluctance torque is highly sensitive to saturation of the rotor material. The second inner magnet 312 is shorter in length L than the first inner magnet 310 to achieve a reduction of the magnet amount and delay saturation boosting of torque when magnet flux orientation is in the negative q-axis direction. In the example shown in FIG. 3, one of the second inner magnet 312 is oriented with the d+ axis and the q- axis (d+;q-) and another second inner magnet 312 is oriented with the d- axis and the q+ axis (d-;q+).

FIG. 4 illustrates the rotor section 300 depicted in FIG. 3. In this view, the magnetic field 402 and flux density orientation is shown aligned with the d-axis at no-load (i.e., no stator current and no torque). The magnetic field 402 experiences magnetic flux bending in the negative q-axis direction as the saturation 404 is delayed because the second inner magnet 312 is shorter in length L than the first inner magnet 310. FIG. 4 illustrates

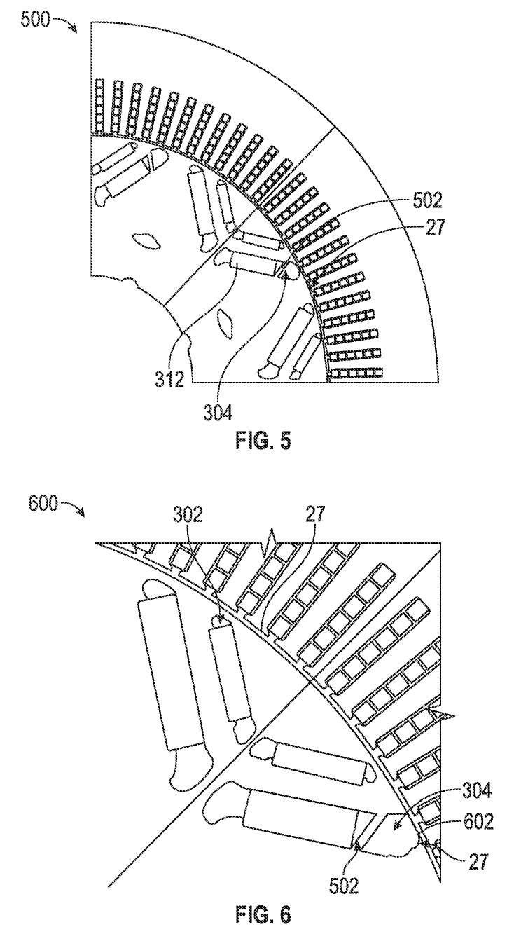

FIG. 5 illustrates an embodiment of a rotor section 500 having a mechanical bridge 502 serving to increase no-load magnetic flux bending and for flux leakage.. In this embodiment, the second inner cavity 304 includes a mechanical bridge 502 disposed between the second inner magnet 312 and the outer rotor surface 27, where the mechanical bridge 502 is partially oriented with the q-axis. The mechanical bridge 502 may include a section of rotor material that traverses the second inner cavity 304 and is intra-polar. The mechanical bridge 502 generates a leakage path that is saturated by the q-flux (i.e., the torque producing flux) and the negative d flux. As discussed above, the mechanical bridge 502 is positioned only in the second inner cavity 304 to achieve the benefits described above and does not act as a flux barrier with respect to the torque producing flux. Within each pole 42, the mechanical bridge 502 is positioned closer to the outer rotor surface 27 than the inner rotor surface 29.

FIG. 6 illustrates an embodiment of a rotor section 600 having a mechanical bridge 502 that provides mechanical strength and also leakage. The second inner cavity 304 extends to the outer rotor surface 27 but does not breach the outer rotor surface 27. The mechanical bridge 502 is aligned with the q-axis and provides less saturation of a q-axis central path due to return flux.

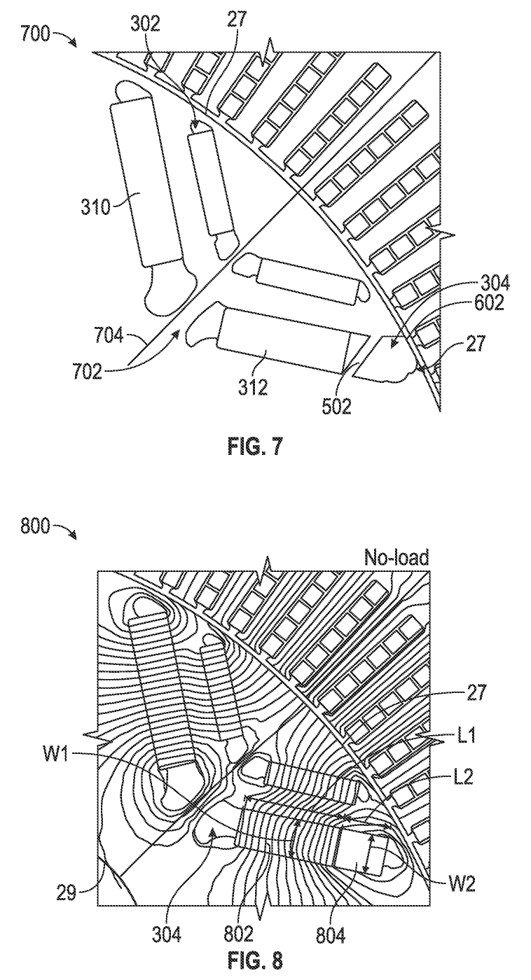

FIG. 7 illustrates an embodiment of a rotor section 700 having a mechanical bridge 502, a leakage bridge 602, and a mechanic web 702. The mechanic web 702 is disposed between the first inner cavity 302 and the second inner cavity 304 and is offset from a rotor pole axis 704 extending along a pole edge toward a rotor center of the pole 42 such that the mechanic web 702 is more proximate the second inner magnet 312 than the first inner magnet 310. The mechanic web 702 is positioned closer to the second inner magnet 312 to reduce flux loop on the web. Magnetic flux in the positive q-axis direction close to the mechanic web 702 serves to increase saturation.

FIG. 8 illustrates an embodiment of a rotor section 800 having a plurality of permanent magnets disposed within the second inner cavity 304. In this example, the plurality of magnets includes a first magnet 802 and a second magnet 804. The first magnet 802 is a different grade (e.g., a higher grade) than the second magnet 804, and the first magnet 802 is positioned closer to the inner rotor surface 29 than the second magnet 804, which is positioned closer to the outer rotor surface 27. Additionally, the first magnet 802 has a width w1 and a length L1, and the second magnet 804 has a width w2 and a length L2. In this embodiment, the width w1 and the width w2 are the same and the length L1 is greater than the length L2.

The differing grade of the permanent magnets 32 may include overall magnetic strength and/or ability to withstand demagnetization. Some examples of permanent magnets 32 with differing grades include neodymium magnets (NdFeB), which are the strongest permanent magnets available with a high magnetic field strength and a high energy density, samarium cobalt magnets (SmCo), which are less powerful than neodymium magnets, ceramic (ferrite) magnets, which have good resistance to demagnetization, alnico magnets, and/or bonded magnets. In one specific example, the first magnet 802 includes a neodymium magnet and the second magnet includes a samarium magnet. It will be appreciated that the first magnet 802 and second magnet 804 may include other types of magnets and/or configurations. A negative q-flux pattern may be obtained when different grades of permanent magnets are combined.

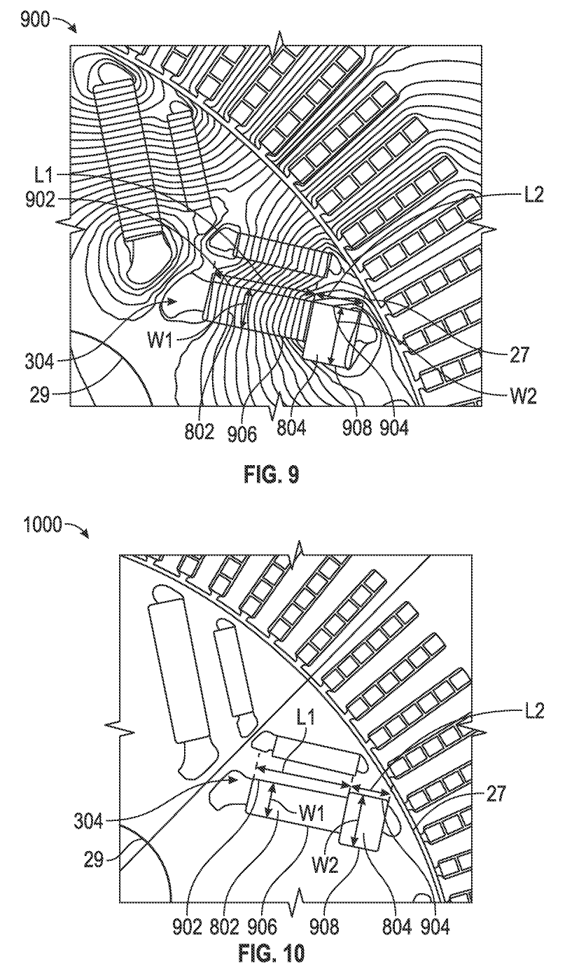

FIG. 9 illustrates an embodiment of a rotor section 900 having a plurality of magnets disposed within the second inner cavity 304. In this example, the plurality of magnets includes a first magnet 802 and a second magnet 804. The first magnet 802 is a different grade than the second magnet 804, and the first magnet 802 is positioned closer to the inner rotor surface 29 than the second magnet 804, which is positioned closer to the outer rotor surface 27. Additionally, the first magnet 802 has a width w1 and a length L1, and the second magnet 804 has a width w2 and a length L2. In this embodiment, the width w2 is greater than the width w2, and the length L1 is greater than the length L2. Further, a first edge 902 of the second magnet 804 is aligned and flush with a first edge 904 of the second magnet 804, and a second edge 908 of the second magnet 804 is offset with a second edge 906 of the first magnet 802. Using a second magnet 804 with a greater width w2 serves to avoid demagnetization of the second magnet 804.

FIG. 10 illustrates an embodiment of a rotor section 1000 having a plurality of magnets disposed within the second inner cavity 304. In this example, the plurality of magnets includes a first magnet 802 and a second magnet 804. The first magnet 802 is a different grade than the second magnet 804, and the first magnet 802 is positioned closer to the inner rotor surface 29 than the second magnet 804, which is positioned closer to the outer rotor surface 27. Additionally, the first magnet 802 has a width w1 and a length L1, and the second magnet 804 has a width w2 and a length L2. In this embodiment, the width w2 is greater than the width w2, and the length L1 is greater than the length L2. Further, a first edge 902 of the first magnet 802 is offset with a first edge 904 of the second magnet 804, and a second edge 908 of the second magnet 804 is offset with a second edge 906 of the first magnet 802. Using a second magnet 804 with a greater width w2 serves to avoid demagnetization of the second magnet 804 and avoids central path saturation.

The rotor 26 and electric motor 12 of the present disclosure are advantageous and beneficial over prior art. The rotor 26 and electric motor 12 provide a higher efficiency in a driving cycle and a lower amount of permanent magnets. The permanent magnets are asymmetrically arranged and used to give the magnetic flux density in the rotor 26 an orientation along the negative q-axis allowing a delay of rotor saturation and increasing reluctance torque.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A rotor, comprising:
a rotor core defining an outer rotor surface and an inner rotor surface opposite the inner rotor surface, wherein the rotor core includes a plurality of poles arranged annularly about a rotational axis,
a plurality of rotor cavities defined by each of the plurality of poles, wherein the rotor cavities are disposed near the outer rotor surface, wherein the plurality of rotor cavities includes at least a first subset and a second subset of rotor cavities spaced apart from each other, wherein the first subset includes a first inner cavity and a second inner cavity in a V-shaped configuration, wherein the second subset includes a first outer cavity and a second outer cavity in a V-shaped configuration, and wherein the second subset is disposed between the first subset and the outer rotor surface; and
a plurality of permanent magnets respectively disposed in one of the plurality of rotor cavities, wherein the plurality of permanent magnets includes a first inner magnet disposed in the first inner cavity and a second inner magnet disposed in the second inner cavity, wherein the second inner magnet is shorter in length than the first inner magnet.

2. The rotor in claim 1, wherein the plurality of permanent magnets includes an alloy of a rare earth element including at least one of neodymium or samarium.

3. The rotor in claim 1, wherein the second inner magnet is equal in length to each of the plurality of permanent magnets in the second subset.

4. The rotor in claim 1, wherein the second inner cavity includes a mechanical bridge disposed between the second inner magnet and the outer rotor surface, and wherein the mechanical bridge is aligned with a q-axis.

5. The rotor in claim 4, wherein a leakage bridge is disposed between the second inner cavity and is aligned with a q-axis.

6. The rotor in claim 1, wherein a mechanic web is disposed between the first inner cavity and the second inner cavity, and wherein the mechanic web is offset from a center pole axis extending through a rotor center to a center of a pole such that the mechanic web is more proximate the second inner magnet than the first inner magnet.

7. The rotor in claim 1, wherein a first magnet and a second magnet are disposed in the second inner cavity, and wherein the first magnet is a different grade than the second magnet.

8. The rotor in claim 7, wherein the first magnet has a higher grade than the second magnet, and wherein the first magnet is positioned closer to a rotor center than the second magnet.

9. The rotor in claim 7, wherein the second magnet has a greater width than the first magnet, a first edge of the second magnet is aligned with a first edge of the first magnet, and a second edge of the second magnet is offset with a second edge of the first magnet.

10. The rotor in claim 7, wherein the second magnet has a greater width than the first magnet, a first side of length of the second magnet is offset with a first side of length with the first magnet, and a second side of length of the second magnet is offset with a second side of length of the first magnet.

11. An electric motor, comprising:
a stator including a plurality of electrical conductors; and
a rotor concentrically disposed relative to the stator, wherein the rotor is rotatable relative to the stator about a rotational axis, and wherein the rotor is spaced apart from the stator to define an air gap between the stator and the rotor, the rotor including
a rotor core defining an outer rotor surface and an inner rotor surface opposite the inner rotor surface, wherein the rotor core includes a plurality of poles arranged annularly about the rotational axis,
a plurality of rotor cavities defined by each of the plurality of poles, wherein the rotor cavities are disposed near the outer rotor surface, wherein the plurality of rotor cavities includes at least a first subset and a second subset of rotor cavities spaced apart from each other, wherein the first subset includes a first inner cavity and a second inner cavity in a V-shaped configuration, wherein the second subset includes a first outer cavity and a second outer cavity in a V-shaped configuration, and wherein the second subset is disposed between the first subset and the outer rotor surface, and
a plurality of permanent magnets respectively disposed in one of the plurality of rotor cavities, wherein the plurality of permanent magnets includes a first inner magnet disposed in the first inner cavity and a second inner magnet disposed in the second inner cavity, wherein the second inner magnet is shorter in length than the first inner magnet.

12. The electric motor in claim 11, wherein the second inner magnet is equal in length to each of the plurality of permanent magnets in the second subset.

13. The electric motor in claim 11, wherein the second inner cavity includes a mechanical bridge disposed between the second inner magnet and the outer rotor surface, and wherein the mechanical bridge is aligned with a d-axis.

14. The electric motor in claim 13, wherein a leakage bridge is disposed between the second inner cavity and is aligned with a q-axis.

15. The electric motor in claim 11, wherein a mechanical web is disposed between the first inner cavity and the second inner cavity, and wherein the mechanic web is offset from a center pole axis extending through a rotor center through a center of a pole such that the mechanic web is more proximate the second inner magnet than the first inner magnet.

16. The electric motor in claim 11, wherein a first magnet and a second magnet is disposed in the second inner cavity, and wherein the first magnet is a different grade than the second magnet.

17. The electric motor in claim 16, wherein the first magnet has a higher grade than the second magnet, and wherein the first magnet is more proximate to a center pole axis than the second magnet.

18. The electric motor in claim 16, wherein the second magnet has a greater width than the first magnet, a first side of length of the second magnet is aligned with a first side of length with the first magnet, and a second side of length of the second magnet is offset with a second side of length of the first magnet.

19. The electric motor in claim 16, wherein the second magnet has a greater width than the first magnet, a first side of length of the second magnet is offset with a first side of length with the first magnet, and a second side of length of the second magnet is offset with a second side of length of the first magnet.

20. An electrified vehicle, comprising:
an electric drive system having an electric motor including
a stator including a plurality of electrical conductors; and
a rotor concentrically disposed in relation to the stator, wherein the rotor is rotatable relative to the stator about a rotational axis, and wherein the rotor is spaced apart from the stator to define an air gap between the stator and the rotor, the rotor including
a rotor core defining an outer rotor surface and an inner rotor surface opposite the inner rotor surface, wherein the rotor core includes a plurality of poles arranged annularly about the rotational axis,
a plurality of rotor cavities defined by each of the plurality of poles, wherein the rotor cavities are disposed near the outer rotor surface, wherein the plurality of rotor cavities includes at least a first subset and a second subset of rotor cavities spaced apart from each other, wherein the first subset includes a first inner cavity and a second inner cavity in a V-shaped configuration, wherein the second subset includes a first outer cavity and a second outer cavity in a V-shaped configuration, and wherein the second subset is disposed between the first subset and the outer rotor surface, and
a plurality of permanent magnets respectively disposed in one of the plurality of rotor cavities, wherein the plurality of permanent magnets includes a first inner magnet disposed in the first inner cavity and a second inner magnet disposed in the second inner cavity, wherein the second inner magnet is shorter in length than the first inner magnet.
